(19) United States
(12) Patent Application Publication
(10) Pub. No.: US 2013/0024931 A1
(43) Pub. Date: Jan. 24, 2013

(54) DOWNLOADABLE COMMUNICATION SOFTWARE TOOL FOR FLASH MEMORY DEVICE

(71) Applicant: Steve W. KIM, Cerritos, CA (US)

(72) Inventor: Steve W. KIM, Cerritos, CA (US)

(73) Assignee: WEMAGIN TECHNOLOGY LLC, Cerritos, CA (US)

(21) Appl. No.: 13/452,774

(22) Filed: Apr. 20, 2012

Related U.S. Application Data
(60) Provisional application No. 61/510,323, filed on Jul. 21, 2011.

(51) Int. Cl. G06F 21/00

(52) U.S. Cl. 726/16

(57) ABSTRACT

A flash memory device is provided that includes an operating system. The operating system has security features such as password protection and/or encryption. Further, the host computer to which the flash memory device is removably attached does not retain any electronic trail of the attachment, usage, communication, or other activity by the flash memory device. The operating system operates on the host computer without the host computer being able to detect and store information related to the operation of the flash memory device. An email service is also provided including timed deletion of emails between registered users. A browser is provided that has auto-populating multi-search, as well as tabbing capabilities. Cloud capabilities are provided, including a desktop run from the cloud as well as a browser run from the cloud. A clickless user interface is provided.

### BACKGROUND

1. Field

Aspects of the exemplary embodiments relate to a portable, secure storage and communication device (for example, but not by way of limitation, a universal serial bus (USB) flash memory) that is preloaded with an operating system and user interface. Further aspects of the exemplary embodiments relate to a mechanism to have the data stored on the storage and communication device and/or remotely (e.g., “cloud”) with synchronization, and a user interface (UI) having operation that does not require mouse clicking

2. Related Art

In the related art, there has been an embodiment includes security with portable storage, such as a USB “thumb drive”. To address this issue, related art solutions include proprietary hardware solutions such as special circuitry, or firmware on the USB device. For example, US Patent Application 2008/0066174 A1 Entitled “Secure Memory Storage Device”, presents a manner of secure storage that requires proprietary hardware; the USB storage device itself has buttons and a display to create the password protection environment. Additionally, US Patent Application 2007/0112981 A1 Entitled “Secure USB Storage Device” depicts a USB storage device with an integrated display and buttons to allow entry of a PIN to protect/access data.

The related art solution on the USB device provides for encryption, password protection, and timed data erasure. For example, U.S. Pat. No. 7,735,145 B2, Entitled “Portable Secure Media with Timed Erasure”, presents a USB storage device with specialized hardware to perform a timed erasure of the data on the thumb drive. US Patent Application 2010/0293374 A1, Entitled “Secure Portable Memory Storage Device” depicts a wireless secure authentication system to control transfer of data over USB.

However, such solutions may require a high cost and are thus directed to commercial rather than consumer markets. For example, the solutions may be directed to corporate, military and legal markets, rather than an average consumer.

Further, the related art portable storage device is limited in terms of its relative capabilities for transport of data, documents and applications. For example, but not by way of limitation, the related art portable storage application cannot match the capabilities of standard computing devices, including personal computers, laptops, notebooks, or the like, in areas such as speed of application launch, usability and aesthetics, versatility, and cross-platform support.

Another related art issue involved the use of a “guest computer”, that is not the device that a user owns or typically uses. For such a “guest computer”, other users may have access. Thus, there is an unmet related art need for users to be able to use a “guest computer” without having unauthorized users access the data, cache files, and any footprint of the computing session on the “guest computer”.

Also, in the related art, portable storage may be lost, forgotten, or otherwise separated from a user. A reason for such a situation is the requirement for such portable devices to be coupled to a computer to exchange data. As a result, users may be concerned about risks associated with losing or forgetting a portable storage, e.g., leaving the portable storage plugged into a computer. Users thus do not store sensitive information on the portable storage.

Additionally, in the related art, a user interface requires a user to click a mouse to indicate selection of a cursor. Thus, the user must constantly click a mouse throughout operation on the user interface.

### SUMMARY

According to an exemplary embodiment a smart USB flash drive is provided. More specifically, the exemplary embodiment is username password protected USB Flash Drive. Contact information is available on the opening page if lost. The exemplary embodiment tracks where the USB Flash Drive is, if stolen or lost, and tracks when, where and how often the USB Flash Drive is accessed. Further, the exemplary embodiment customizes where to send the hacker alert; either email or text to multiple devices, and automatically sorts and organizes the different types of files (music, photo, video, document). The exemplary embodiment also synchronizes with the cloud on one or more of a selection of files, and can launch the internet from the USB Flash Drive. Further, a master and slave password and settings account is provided, for corporate and parental controlled access

According to an exemplary embodiment, a smart browser is provided. The smart browser includes Username password protection, and is a portable browser that takes all of your settings on your PC. Using the smart browser, one can open and edit files in your PC or mobile device from the browser, and listen to music on your browser without leaving the browser. Further, the user can customize the color and design of the browser, including adding video or photos; optionally, the browser retracts in and out to make more visible space as needed. The browser is always available regardless of where you are

According to an exemplary embodiment, smart tabs are provided including customizable tab colors and a smart tab controller. Further, simple default search engine setting are provided to set or change the default search engine, and set and change without ever leaving the page or opening a new page.

According to an exemplary embodiment, an auto populating multi search engine is provided. This exemplary embodiment auto populates the search term simultaneously to all the world's top, most visited websites, avoids a need to retype search terms multiple times, avoids a need to move page to page, and saves mouse clicks.

According to an exemplary embodiment, a smart cursor determines when to highlight and when to add a cursor, automatically highlights and activates the cursor in the address bar and search engines box, and eliminates clicking into search or address bars before typing the search terms or the web address.

According to an exemplary embodiment, smart email allows one to access multiple emails simultaneously, and update multiple communication protocols. Smart photo contact is provided, as opposed to typing the email address on the TO, CC or BCC. Further, logging in and out of emails is not required. A user can access email with any computer, without leaving a footprint of the user's username or password.

According to an exemplary embodiment, a desktop cloud is provided, which permits a user to register online to set up the USB Flash Drive, customize a video loop from computer or the internet to the desktop, and/or customize contact information on the desktop page.

According to an exemplary embodiment, a cloud desktop dashboard is provided that permits a user to view emails and social network message alerts on the desktop dashboard.

According to an exemplary embodiment, a clickless mouse/clickless internet is provided, so that a user can surf the web, move objects, click through linked sites without clicking the left or right buttons on the mouse, thus avoiding carpal tunnel damage. No special input device, mouse or other hardware is required, and no software download is required for existing input devices such as a mouse.

According to an exemplary embodiment, smart texting permits texting from any computer, anywhere in the world to any cell phone for free. A user may search, organize, label, retrieve, forward, carbon copy, blind copy, add subjects, send attachments and send to multiple receivers simultaneously. Further, the user may text and email from the same email box. Additionally, the user may communicate with emails, social networks and mobile devices together.

An exemplary embodiment, tracks, organizes and calculates people referred. For example, the exemplary embodiment tracks who was registered through who, when and where worldwide, tracks the traffic and growth of the group, and tracks the growth of people registered by time, place and usage by every level. Thus, the first search engine may reward those responsible for referral

The exemplary embodiments are directed to a combination of software/operating system environment preloaded on a portable storage (e.g., USB flash drive or other removable media) that may have a low cost, as well as a remote server environment that manages data storage and transfer functions, including but not limited to registration, authentication, and secure transfer of sensitive documents and emails. The exemplary embodiments include clickless operation.

According to an exemplary embodiment, the software/operating system environment includes a set of instructions that is loaded into the computer-readable information storage medium of the portable storage. There is no requirement for any additional or modified hardware. Thus, the operating system can be loaded without requiring proprietary hardware to storage devices such as USB flash drives.

Additionally, an exemplary embodiment includes a secure storage scheme that can lock each file and provide password-protected encryption thereto.

Another exemplary embodiment is directed to allowing a user to use a computer via the operating system of the portable device, so that any activity on the computer is not stored in the operating system of a host computer for the portable device, and thus leaves no “footprint” on the host computer. For example, but by way of limitation, private internet browsing is provided.

Yet another exemplary embodiment is directed to a central server/web based solution for user registration and remote administration for the portable storage.

A further exemplary embodiment is directed to a secure email system that is operated from the portable storage. For example, the secure email system may provide password protected privacy, encrypted storage, timed deletion of messages, and as disclosed above, no footprint on the host computer.

Additionally, an exemplary embodiment provides for a messaging system on the portable storage. The messaging system permits user-to-user (e.g., peer-to-peer) messaging and data exchange via a communication protocol (e.g., email) on the portable storage, and does not include spam and virus.

An exemplary embodiment is also directed to secure storage of user information that may be characterized as sensitive or private, such as account numbers, PINS and passwords.

An exemplary embodiment includes a multimedia storage and management system.

In yet another exemplary embodiment, the portable storage provides a user interface. More specifically, a customizable flash and video based user interface may be provided.

The exemplary portable storage may be configured for seamless inter-operation on multiple host operating systems, including but not limited to Windows and Macintosh environments. For example, a portable storage may be used in a host computer that uses a Windows operating system to a host computer that uses a Macintosh operating system without the user noticing any difference in the user interface and the functionality.

Additionally, the exemplary embodiment allows for registered user access, ability to block remotely if device is lost, and remote locate proximity by Internet Protocol (IP) address for unauthorized access (for example, notification can be provided by phone or email). Further, the exemplary embodiment includes a “Lost and Found” feature that allows for a lost portable storage to provide an indication.

Additionally, the exemplary embodiment provides for a user interface of the portable storage that includes a “self destruct” button for quick erasure of determined sensitive data

### BRIEF DESCRIPTION OF THE DRAWINGS

FIG. 1 illustrates an exemplary authentication process;

FIG. 2 illustrates an exemplary relationship establishment process;

FIG. 3 illustrates an exemplary communication process;

FIG. 4 illustrates an exemplary security information storage process;

FIG. 5 illustrates an exemplary hardware device;

FIG. 6 illustrates an exemplary user interface;

FIG. 7 illustrates an exemplary user interface;

FIG. 8 illustrates an exemplary user interface;

FIG. 9 illustrates an exemplary user interface;

FIG. 10 illustrates an exemplary user interface;

FIG. 11 illustrates an exemplary user interface;

FIG. 12 illustrates an exemplary user interface;

FIGS. 13A, 13B and 14 illustrate exemplary processes for usage of a clickless user interface;

FIG. 15 illustrates an exemplary process for texting; and

FIGS. 16A-16F illustrate operation of the clickless user interface

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves those of ordinary skill in the art. Descriptions of well-known functions and structures are omitted to enhance clarity and conciseness.

Aspects of the inventive concept are directed to a flash memory device, such as a USB memory (e.g., removable, mobile memory). The USB memory includes an independent operating system (OS). The OS may be downloaded onto an existing USB memory that has been used without such an OS, or may be installed on a newly manufactured USB memory. For example, but not by way of limitation, the download may be offered as a free download from a website. According to the inventive concept, the user interface may not require a user to click an input device (e.g., mouse), hereinafter referred to as “clickless”.

The flash memory device having the aforementioned OS has security features, such an encryption and/or password protection. Accordingly, a flash memory can be “converted” to a security-protected flash memory by installation of the OS.

The OS may have various characteristics. In one exemplary embodiment, the OS generates its own user interface (UI), such as a graphical user interface (GUI). According to this exemplary embodiment, the flash memory can be used on a device having a processor, such as a personal computer (PC), netbook, notebook, or other device as would be understood by one skilled in the art. For the sake of clarity, the term “PC” is used to describe the device to which the flash memory is connected, although other devices may be used without departing from the scope of the inventive concept.

After usage, the OS eliminates any electronic trail on the PC, such that there is no data on the PC indicating that the flash memory was ever connected to the PC. For example, but not by way of limitation, there would be no electronic data or other evidence in any part of the PC that would allow a user to ascertain that the flash memory containing the OS was connected to the PC. The flash memory leaves no electronic trail on the PC once removed.

Additionally, the flash memory OS has its own email service, search engine, and other online features, all of which also have no electronic trail.

More specifically, the inventive concept discloses secure storage of data, as well as unsecure, unencrypted data, as determined by a user. For example but not by way of limitation, casual transfer of transient files, images, music etc, can be accomplished by using the flash drive as an unencrypted transient storage device. On the other hand, for the secure aspect, the user sets up an account with a web server associated with the OS and registers one or more of the flash memory devices that include the OS with a user account. This registration feature can be used for “lost and found” alerts, remote erasures, optional backup data and secure storage on the server, as well as local locking and hiding of files on the flash memory device itself.

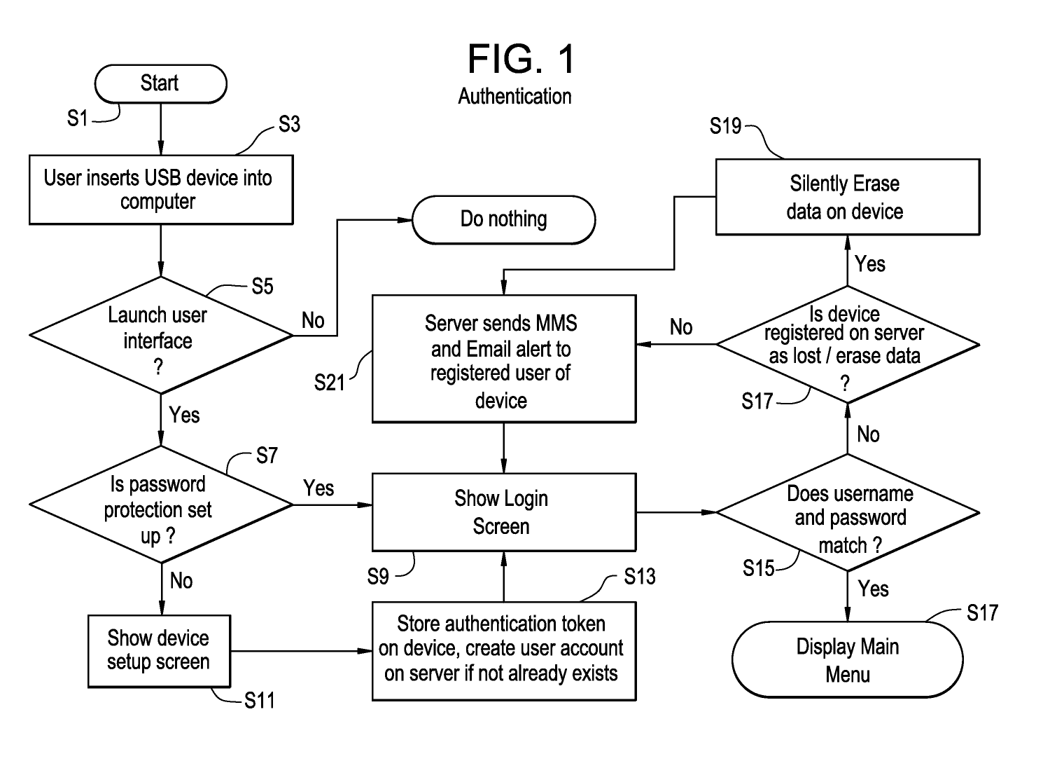

FIG. 1 illustrates an exemplary authentication process. The user starts Si by inserting S3 the flash memory device into a host PC connected to the internet. Depending on the operating system running on the PC itself, the user may be presented with a standard prompt to open the device to explore files, or launch the main user interface of the OS of the flash memory may be launched S5.

If the user interface is launched (e.g., by user command), the software on the flash memory device checks whether local password protection has been set up S7. If so, a login screen is presented to the user S9. If not, the device setup screen is presented to the user S11, allowing the user to create an account if an account does not already exist, or else use their existing account to associate this device with. An authentication token is stored on the flash memory device 13.

From the login screen, the user enters a username and password, and if there is a match between the username and password with respect to a security verification system, a main menu may be displayed S17. If the username and password do not match with respect to a security verification system, then the software confirms whether the flash memory device has been reported as “lost” and/or set to erase data S17. If so, the data on the device is silently erased S19, i.e., the erasure is performed without alerting the user.

After S17 or S19, the server alerts the owner of the device S21. For example, but not by way of limitation, the server transmits an email and SMS message to the registered owner of the device, letting them know of an unauthorized access attempt to the device. The IP address of the host computer where the user attempted access from may also be reported to the registered owner of the device.

When the user successfully enters a username and password, the main menu is shown S17, as explained above.

Secure, SPAM-Free Email

According to an exemplary embodiment, a form of secure, trusted and Spam-free Email that is not available in the related art email is provided. The users of this system are restricted to members who already having a personal trusted working relationship outside of cyberspace. For example, but not by way of limitation, the users of the system can be coworkers, an attorney and client, business partners, etc.

To set up a trusted connection, the users agree in advance on a common passphrase offline (in person, via telephone, etc) to be used when establishing a trust relationship online. According to this exemplary embodiment, SPAM and unwanted Emails, viruses, etc. may be substantially eliminated. Moreover, transmission and storage is encrypted, which may substantially prevent unwanted interception of sensitive communication.

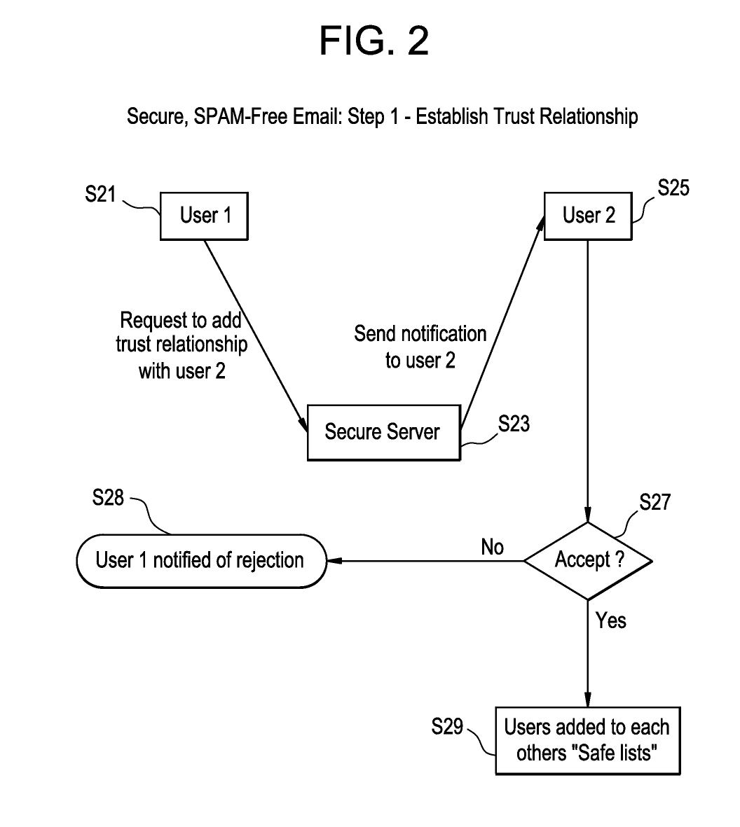

FIG. 2 illustrates establishing a trust relationship according to the exemplary embodiments. At S21, User 1 transmits a trust relationship request to user 2, via a server (e.g., the web portal, or software running on the flash memory device). The request is stored in a queue at S23, for which User 2 will receive a notification at S25 when logged in, through normal message polling. User 2 may accept or reject the request at S27, and accordingly enter the common passphrase as user 1 to accept the request.

If User 2 does not accept the request at S27, then User 1 is notified of the rejection at S28. If user 2 accepts the request at S27, then user 1 and user 2 are added to and at S29 stored in each other's address book “white lists”, and user 1 and user 2 can commonly send and receive messages from each other. Messages can only be sent between user 1 and user 2 via this procedure. Further, this method comprises proprietary messaging Email interface or web portal according to the OS of the flash memory device. Thus, the messages remain secure, encrypted, spam-free, virus-free, and further, do not leave a footprint on the host computer.

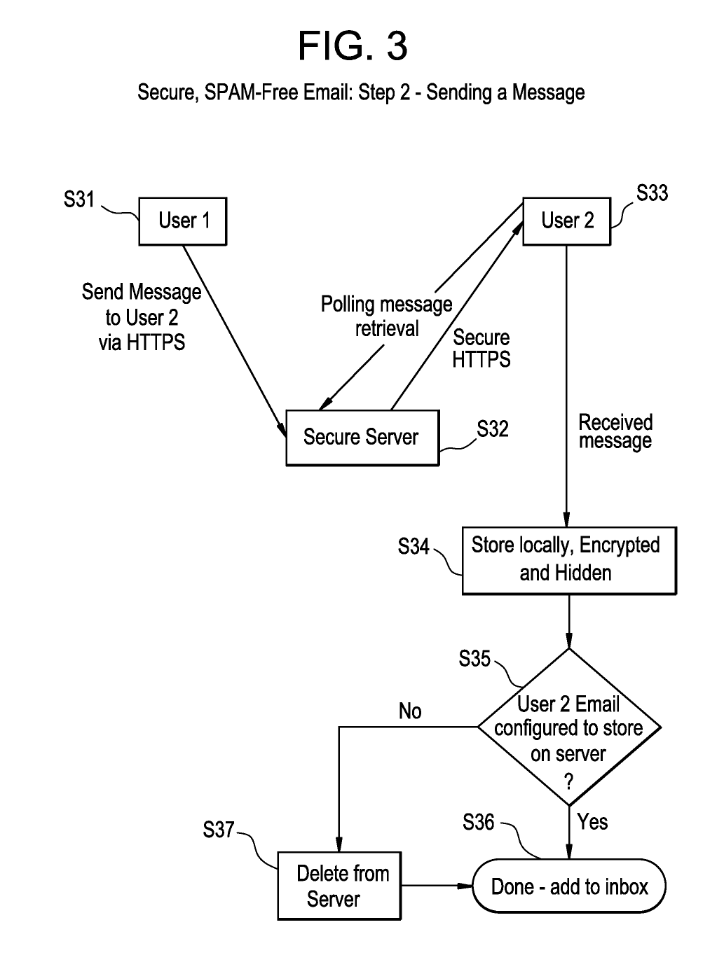

FIG. 3 illustrates message sending and receiving once an established relationship is in place according to an exemplary embodiment. According to this exemplary embodiment, a mechanism for secure storage of passwords, PINS and other account access information is provided. A second-level password, beyond the authentication to access the main menu, is required to access this “virtual safe-box”.

At S31, User 1 sends a message to User 2 via HTTPS. The message is stored in a secure server at S32. At S33, the message is sent to User 2, and polling message retrieval is sent to the secure server.

As shown at S34, the received message is stored locally, encrypted and hidden. At S35, a determination is made as to whether the email message is configured to be stored on the server. If the answer is “Yes”, then the email message is added to the inbox at S36. If the answer is “No”, then the email message is deleted from the server at S37, and subsequently added to the inbox at S36.

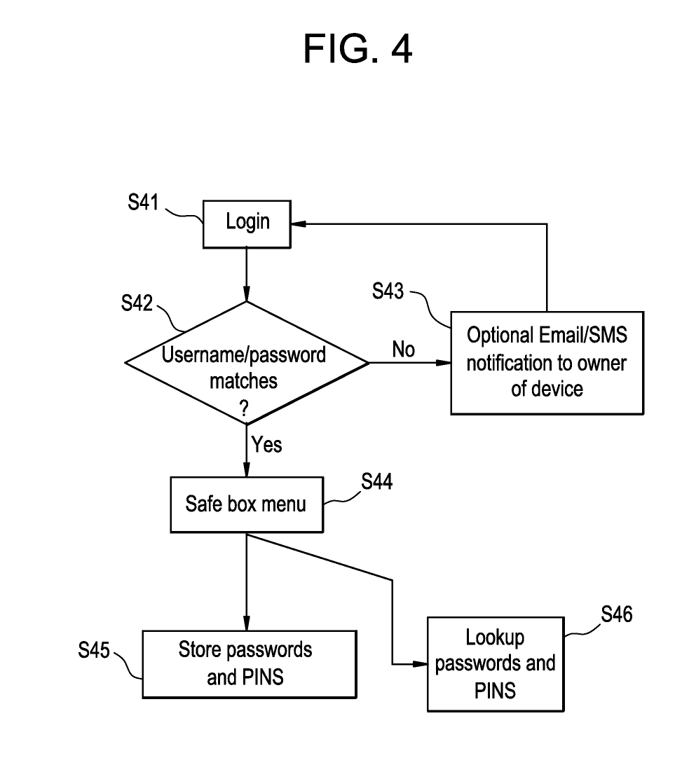

As shown in FIG. 4, a failure of a user to log into this second-level password protected area, can generate an email and/or SMS alert. This provides an additional layer of protection in cases such as the owner of the flash memory device leaving their desk for a few minutes.

At S41, a login operation is performed. At S42, a determination is made as to whether the username and password match, thus indicating verification. If the answer is “Yes”, then a safe box menu appears at S44. If the answer is “No”, then a user may have an email or other notification message sent to the owner of the device at S43, and another opportunity to login is provided as the process returns to S41.

After the appearance of the safe box menu at S44, passwords and other personal identification number (PIN) information may be stored at S45. Further, the passwords and PINS may be retrieved at S46 by the user.

Once the user is logged in, they can store and retrieve account and password information, as well as PINs, for things such as credit cards, bank accounts, online login information, etc.

Example user interfaces according to an exemplary embodiment may include a toolbar. A color of the browser may be changed by selecting an icon. For example a white color may be chosen having a reflective appearance, to give a user a glassy impression of an object such as a mobile communication device. Further, a plurality of icons is provided across the toolbar, each of which may invoke a third party application.

Highlight effects may be provided that distinguish an area on which the user has focused. If a cursor is over certain icons, those icons may be colored so as to give a glow-like appearance, whereas other icons not in an active area may be colored so as to give a dimmed appearance. In an exemplary embodiment, the toolbar has a textured design in its background.

A third party application may be invoked in the user interface of the exemplary embodiment. As explained above, the active icons are indicated in a manner that is distinguishing, as compared with the non-active icons.

An exemplary third party application may be invoked, with the toolbar as described above. The toolbar includes tabs which indicate active and inactive (e.g., hidden) windows. Further, an auto-populating search field is provided.

According to an exemplary utility aspect of the toolbar in the user interface, a series of icons are provided in a horizontal panel. A user may place a cursor over any one of the areas to reveal a selection or a series of additional sub-options in a drop down menu. In this example, a user has chosen a USB icon, and the options include, but are not limited to, making a USB copy, synchronizing operation to the USB, or the PC, and editing.

A plurality of third party applications may be displayed over the invoked third party application. A user can scroll through the available third party applications, and thus invoke a third party application from the display, while another third party application is open in the background.

A display of image thumbnails may include a title. Further, a user may select from a plurality of options, include, but not limited to, music, video, photo, and editing, thus permitting the user to focus to a different type of content. Similarly, video thumbnails, and viewable document thumbnails may be provided. One or more of the files may be locked or have a security restriction of some sort.

Options for the UI settings may also be provided. A user may set their profile, including an associated photo, a tag line, a user name, a password, contact information, hacker alert email address, hacker alert text, and a setting for an inactivity alert. A video setting option is provided that allows the user to set colors (e.g., by using a color palette). A ticker may be added to the browser as well. A browser setting allows a user to upload a skin image for a background.

Communication options for the UI settings are also provided. For example, a user may select from a plurality of communication services, and include their username and password. Further, the user may turn any of the communication services ON or OFF.

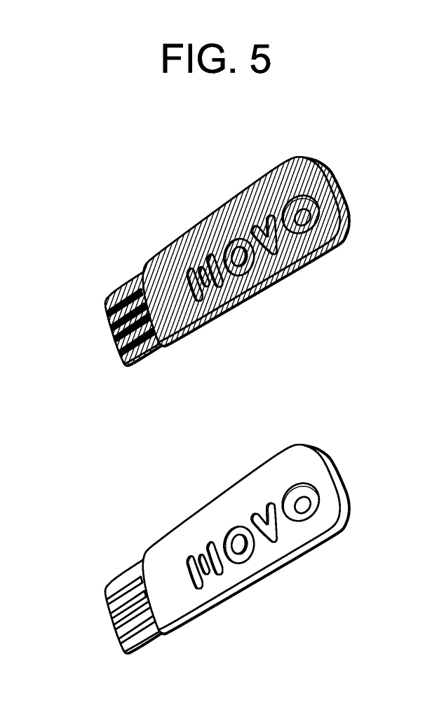

According to an exemplary embodiment, the flash memory device is a USB flash drive, as shown in FIG. 5. The USB flash drive may include a security system that has username password protection. According to the OS, an opening page may be provided, including contact information for returning the USB flash drive, in case it is lost. If the USB flash drive is registered by the owner as lost or stolen, or if unauthorized access is attempted, the exemplary embodiment tracks the IP address of the device with which the USB flash drive has been connected. Thus, the location of the USB flash drive can be tracked.

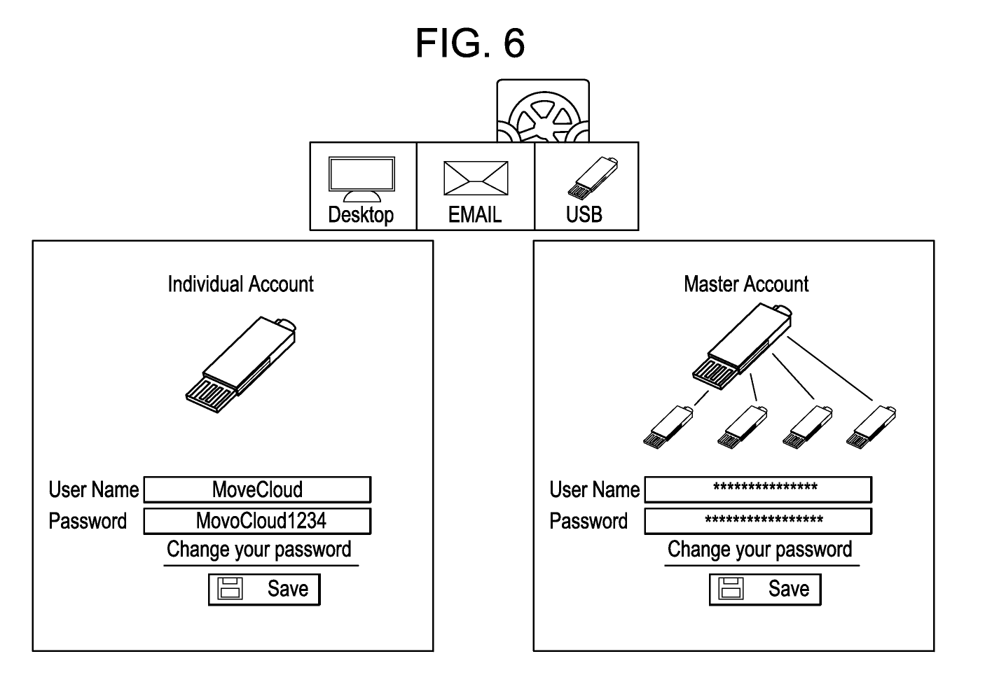

FIG. 6 illustrates USB setting options. More specifically, username and password may be provided for an individual account and/or a master account. The user has the option to access an individual account for the USB memory device in question as indicated by “Individual Account” in FIG. 6. The user may toggle between the desktop, an email communication service (e.g., cloud or other), and the USB memory. Similarly, settings may be performed for a plurality of USB devices at a “Master Account” level.

According to a communication aspect of the user interface, a self-destruct date may be provide for the communication. For example, a user may send an email, and have the email self-destruction after a certain period, or at a selected time.

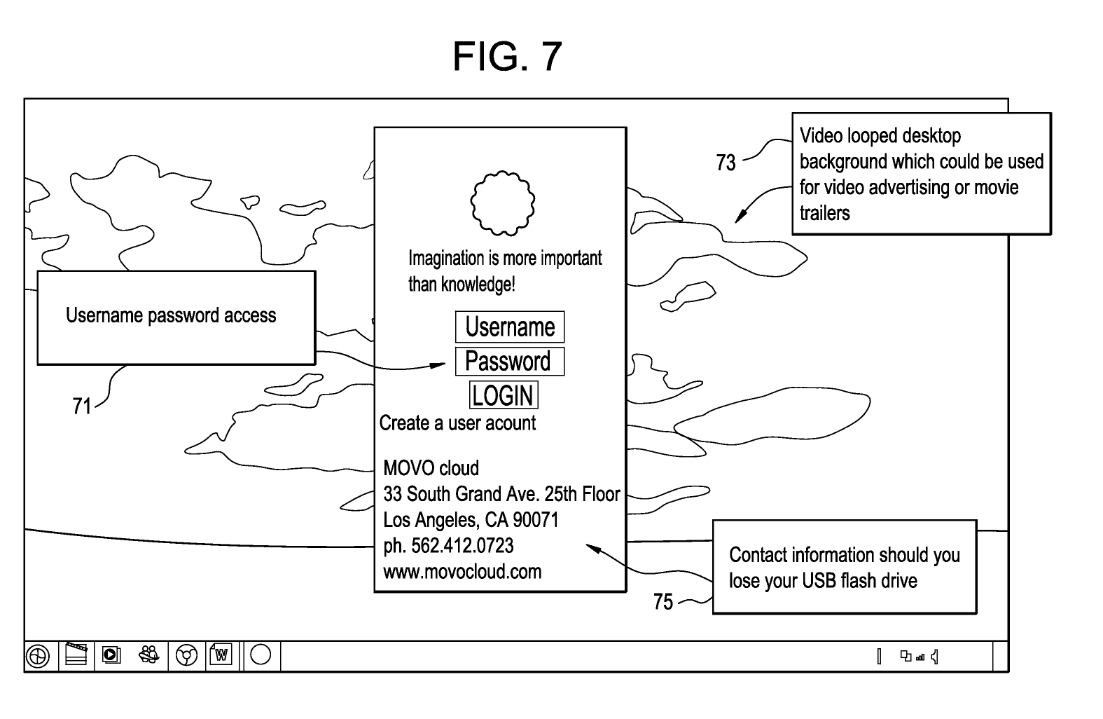

FIG. 7 illustrates an exemplary login screen for the user interface. This login screen may appear when a user couples the USB to a processor such as a PC. In the example embodiment, the user is prompted to provide a username and password at 71, and then may activate a login object, e.g., button to initiate the validation of the username and login. As shown at 73, a looped video may be played in the background of the login screen. For example but not by way of limitation, this video may include information, such as advertisement or movie trailers. Alternatively, information selected by the user, such as videos or images, may be displayed. At 75, contact information is provided for the user, in the event of loss of the USB memory device.

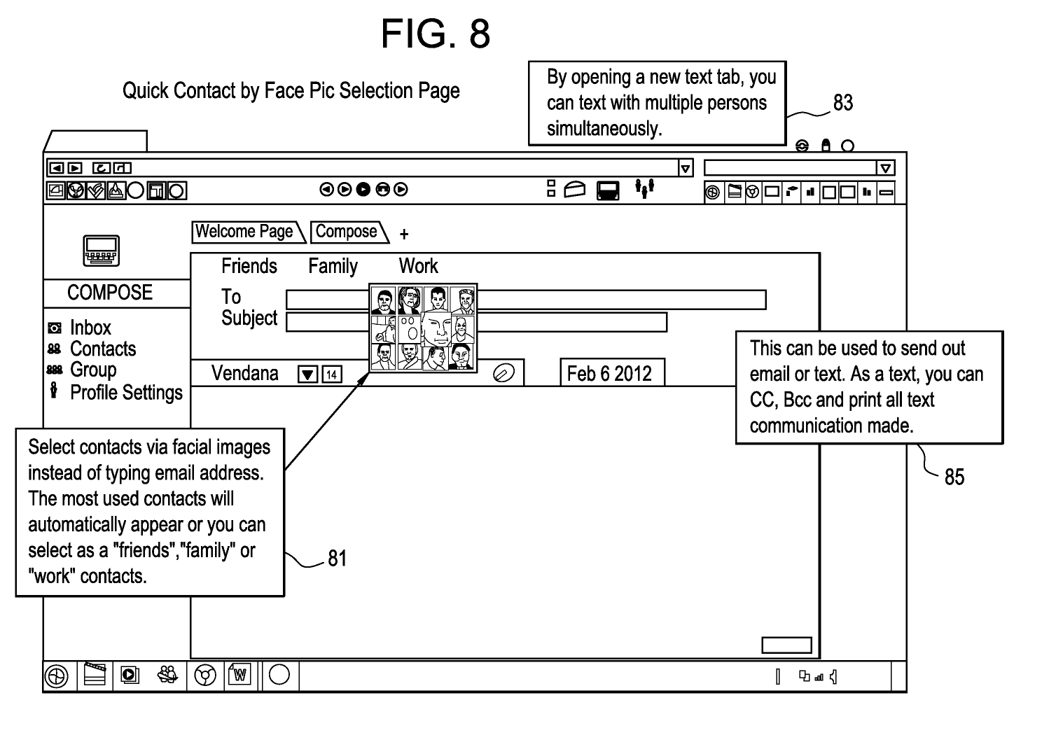

FIG. 8 illustrates an email interface using the email communication service according to the exemplary embodiment. As shown in FIG. 8, images 81, such as facial images) may be used as a basis for selecting an email recipient. For example, such images may be used instead of text-based identifiers. The images may appear automatically, or based on “family”, “friends”, or other group of contacts. At 83, by opening a new tab, it is possible for the user to send text messages to multiple recipients simultaneously. Further, as shown in 85, the message can be sent as an email or as a text message. When sent as a text message the user can CC, BCC, and print all text communications.

When a user mouses over an image, that image may be provided in a display having an enlarged or otherwise modified appearance. Thus, the user may select an addressee or recipient of email based on an image, and without requiring text-based identification. For example, and as explained above, FIG. 8 illustrates the appearance of the image files and/or the text appearance of the email address in the address fields of the communication interface.

According to an exemplary interface, in which the user has displayed a plurality of incoming messages, the user is displayed an image associated with the sender of the email, as well as the text name of the sender. The subject, attachment, time of receipt, and date of receipt are also displayed. According to this example embodiment, a text-based input page is provided to the user.

In a communication portion of the user interface in which a user has many objects in the tool bar (e.g., browser bar), an option is provided so that a user can pull down or push up to remove the objects from the tool bar.

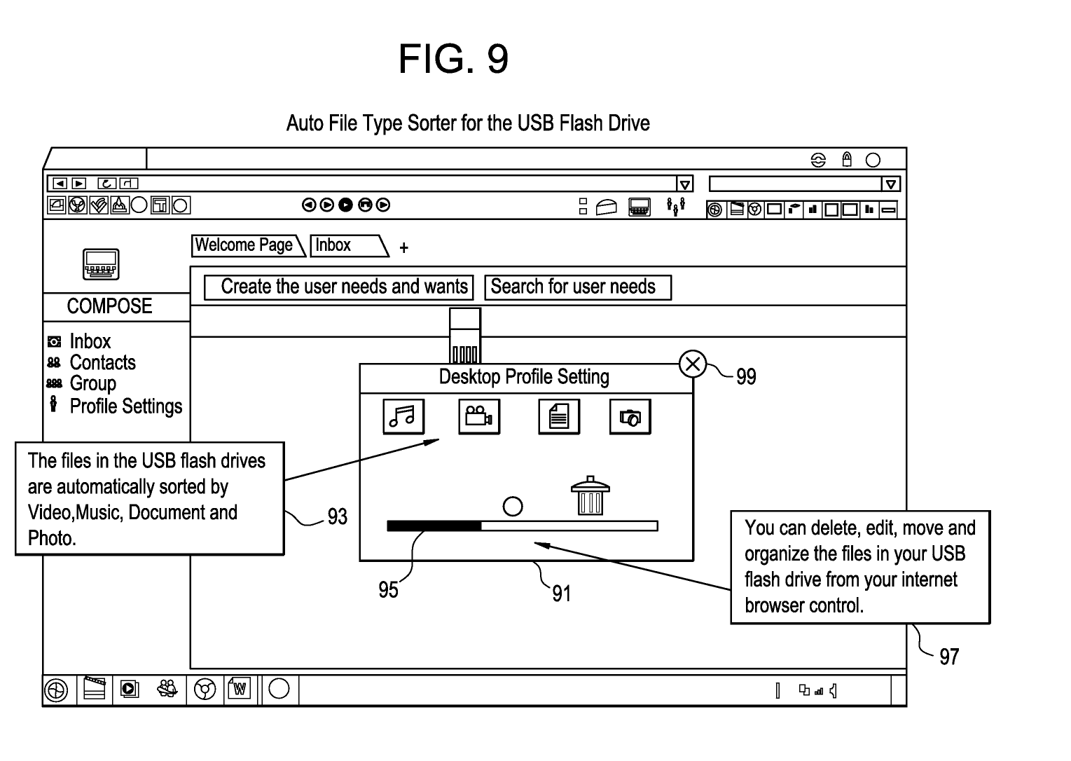

FIG. 9 illustrates a file type sorter according to the exemplary embodiment. In this exemplary embodiment, a pop-up window 91 is provided to the user. Icons 93 associated with the plural file types (e.g., audio, video, text, image) are displayed to sort the files. An indicator 95 (e.g., bar at bottom of popup window) is provided, which indicates the remaining available memory on the portable memory (e.g., USB memory). As shown at 97, icons indicative of a delete or purge function (e.g., trash can symbol) and an add function (e.g., encircled “+” symbol) are also provided. Further, an object 99 that permits a user to close to popup window is also provided (e.g., “X”).

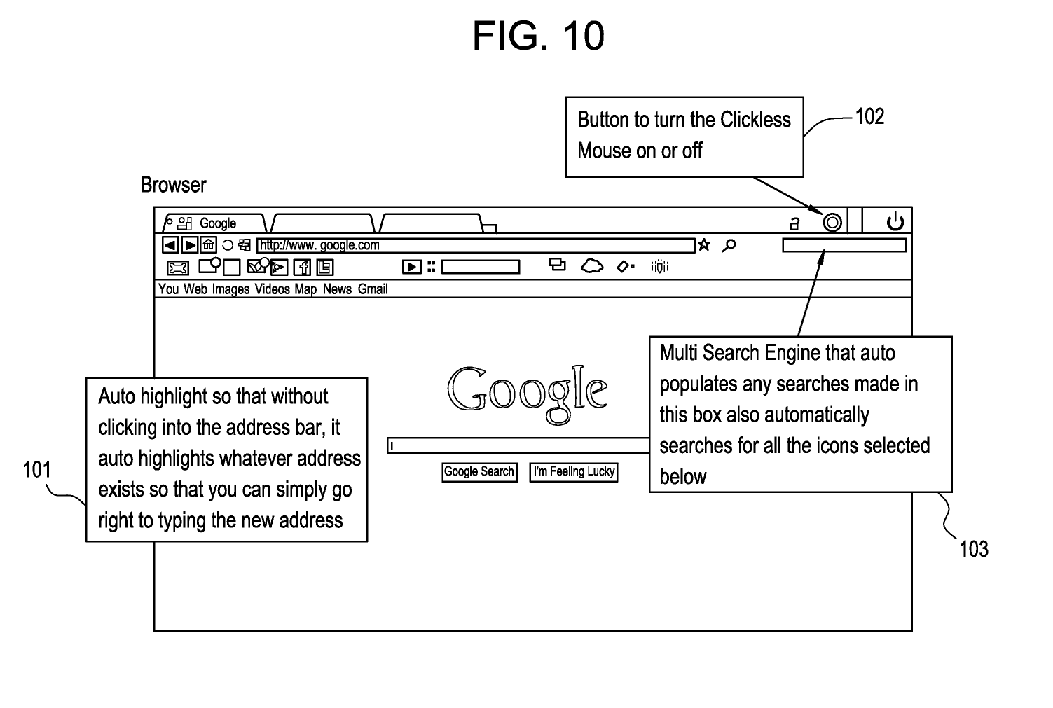

FIG. 10 illustrates an exemplary browser. More specifically, an online website including a user query tool is opened, such that the user can perform web browsing from within the application that is controlled from the flash memory device.

At 101, auto highlighting is provided, such that without the user having to click in the address bar, the auto highlight highlights the currently existing address, so that the user can immediately type in the address to be browsed. An object 102 is provided to toggle a clickless mouse function as disclosed below to have its functionality toggled between an ON state and an OFF state. At 103 a multi search engine is provided such that searches may be automatically populated for the actual browser itself at 103.

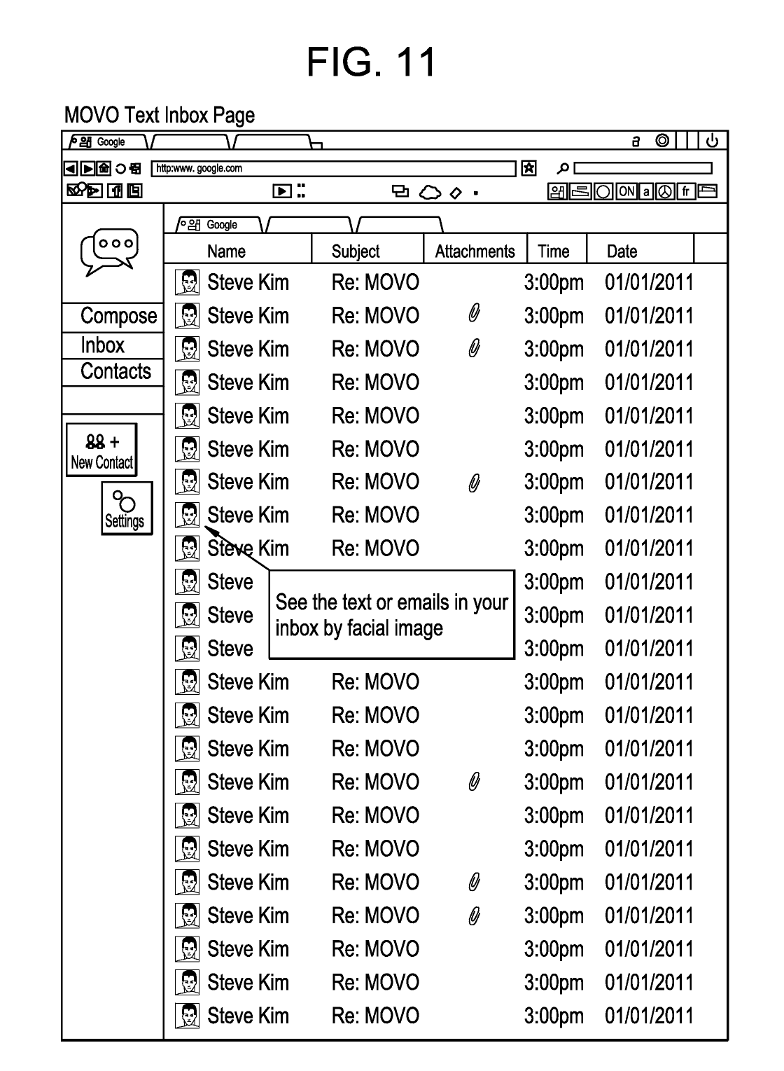

FIG. 11 illustrates an exemplary contact edit page. In the exemplary interface, a user may activate the contact information of the email sender by selecting the user based on a facial image.

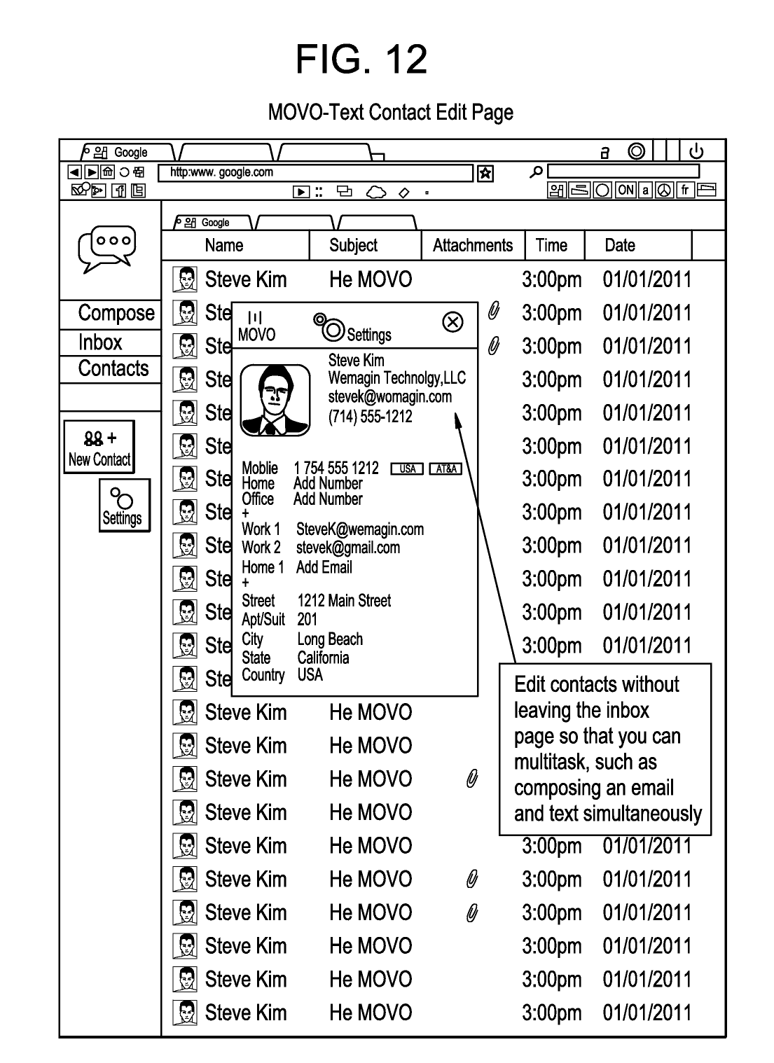

As shown in FIG. 12, the profile of the sender is displayed, and the user may edit various forms of contact information, including but not limited to phone, address, email, name, and organizational contact. This editing can be performed while other tasks are being performed, such as composing an email and text substantially simultaneously.

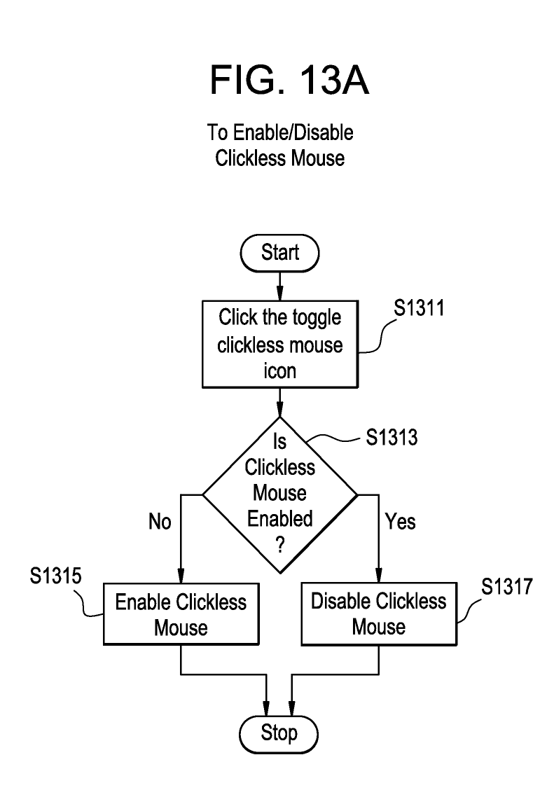

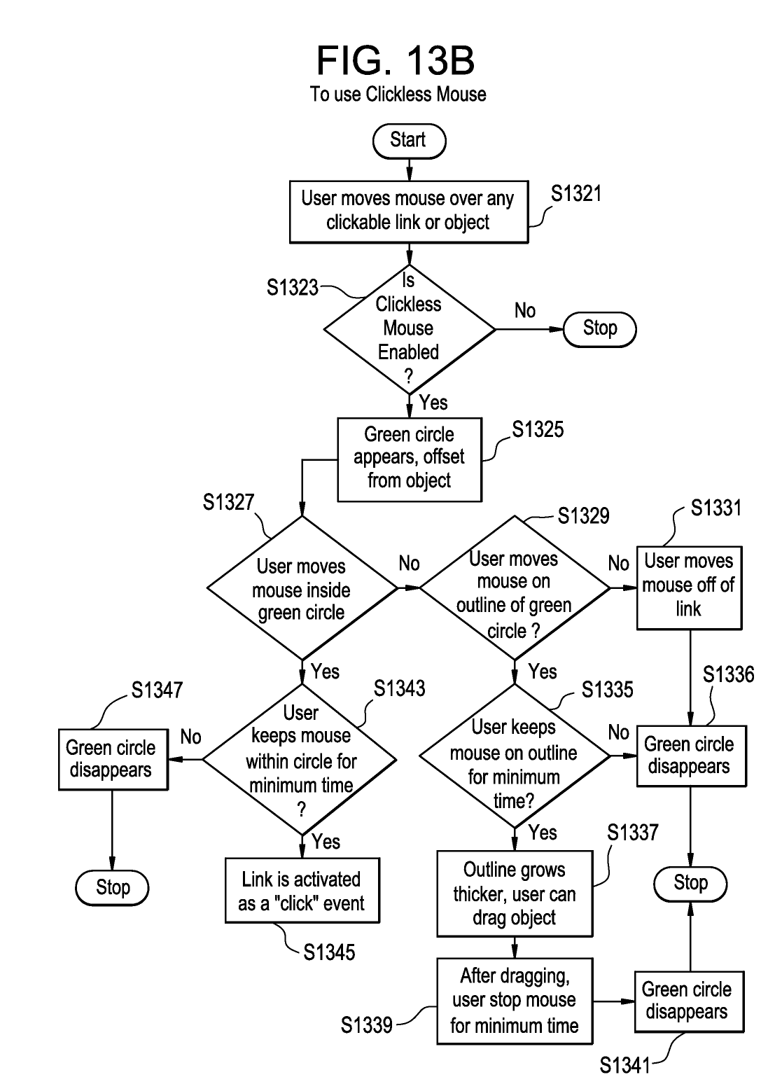

FIG. 13A illustrates operation of a clickless user interface, also referred to as “clickless mouse” according to an exemplary embodiment. In a first process for enablement or disablement, at S1311, a toggle may be selected by a user. At S1313, it is determined whether the clickless mouse has been enabled. If the clickless mouse has not been enabled, at S1315 the clickless mouse is enabled. If the clickless mouse has been enabled, at S1317 the clickless mouse is disabled.

FIG. 13B also illustrates use of the clickless mouse. At S1321, a user moves the mouse cursor over any clickable link or object. At S1323, it is determined whether the clickless mouse feature has been enabled. If this feature has not been enabled, the clickless mouse use process terminates.

If the clickless mouse feature is determined to be enabled at S1323, then at S1325, an indicator (such as a shaded circle, for example but not by way of limitation, shaded in a patterned or non-patterned color or colors, such as green, but not limited thereto) appears, offset from the object. At S1327, it is determined whether a user moves the mouse cursor to a position inside the indicator. If it determined at S1327 that such movement has not occurred, then it is determined if the user has moved the mouse cursor to a position on an outline of the indicator at S1329.

If the user has not moved the mouse cursor to a position outside of the indicator, then at S1331, the user moves the mouse off the link, and at S1333 the indicator disappears, and the process is terminated.

If the user has moved the mouse cursor on an outline of the indicator as determined at S1329, it is then determined whether the mouse cursor has remained on the outline for a minimum at time S1335. If not, the indicator disappears at S1333 as explained above and the process terminates.

If the mouse cursor is determined to have remained on the outline of the indicator for the minimum time at S1335, then outline of the indicator transforms its appearance (e.g., the outline grows thicker) at S1337, and the user can then drag the object. At S1339, after the user has stopped dragging the object for a minimum time, the drag function is inactivated and the indicator disappears at S1341, after which point the process terminates.

If the user has moved the mouse cursor inside the indicator as determined at S1327, then at S1343, it is determined whether the mouse cursor has been kept within the indicator (e.g., inside of the shaded circle) for a minimum time. If so, the object (e.g., link) is activated as a “click” event. If not, the indicator disappears at S1347.

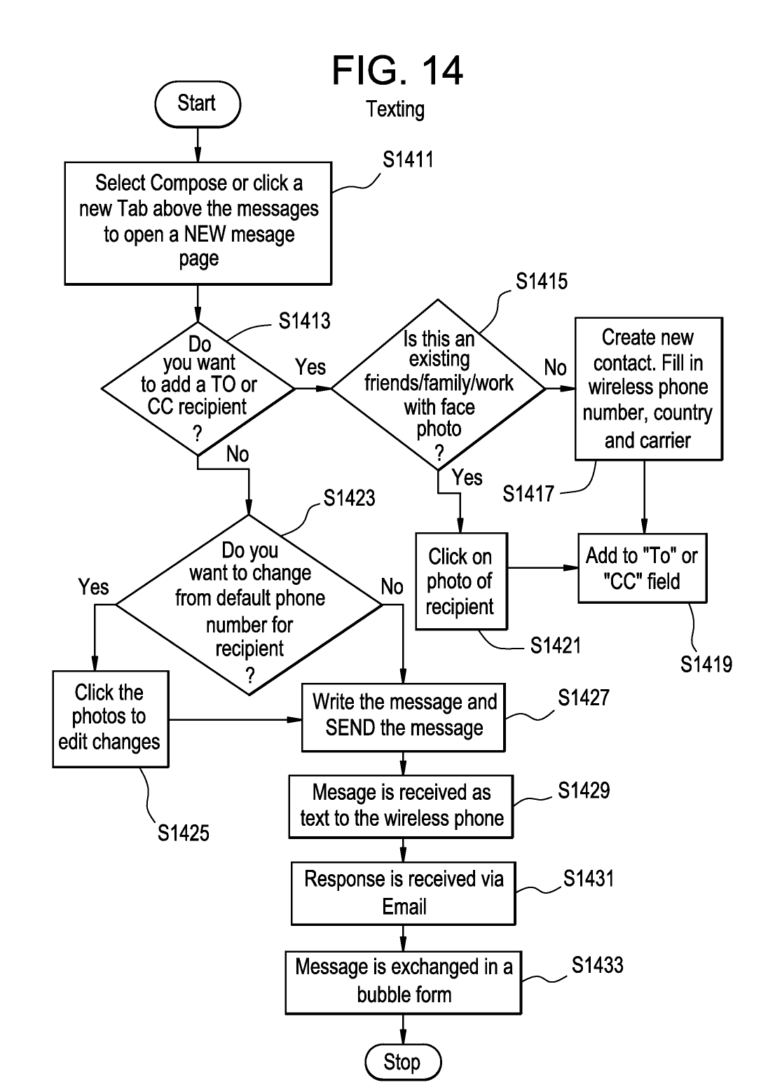

FIG. 14 illustrates an exemplary texting process. As shown in S1411, in a user interface according to the exemplary embodiments, the “compose” option may be selected, or a new tab may be selected above the messages, so as to open a “new” message page.

At S1413, it is determined whether a TO or CC recipient is desired. If the answer is YES, then at S1415, it is determined whether the recipient is an existing addressee with an image (e.g., face photo). If so, then a user may select the image at S1421. If not, a new contact may be created at S1417 by entering information (e.g., mobile phone number, country, carrier). After either of S1417 or S1421, the TO or CC field is filled in S1419.

If a recipient is not to be added at S1413, it is determined whether a default phone number is to be changed at S1423. If so, a user may select the images and edit the photo at S1425. If not, then at S1427, the message is written and sent. At S1429, the message is received by the recipient was a text to a mobile phone. At S1431, a response is received via email, and at S1433, the message is displayed in a bubble form.

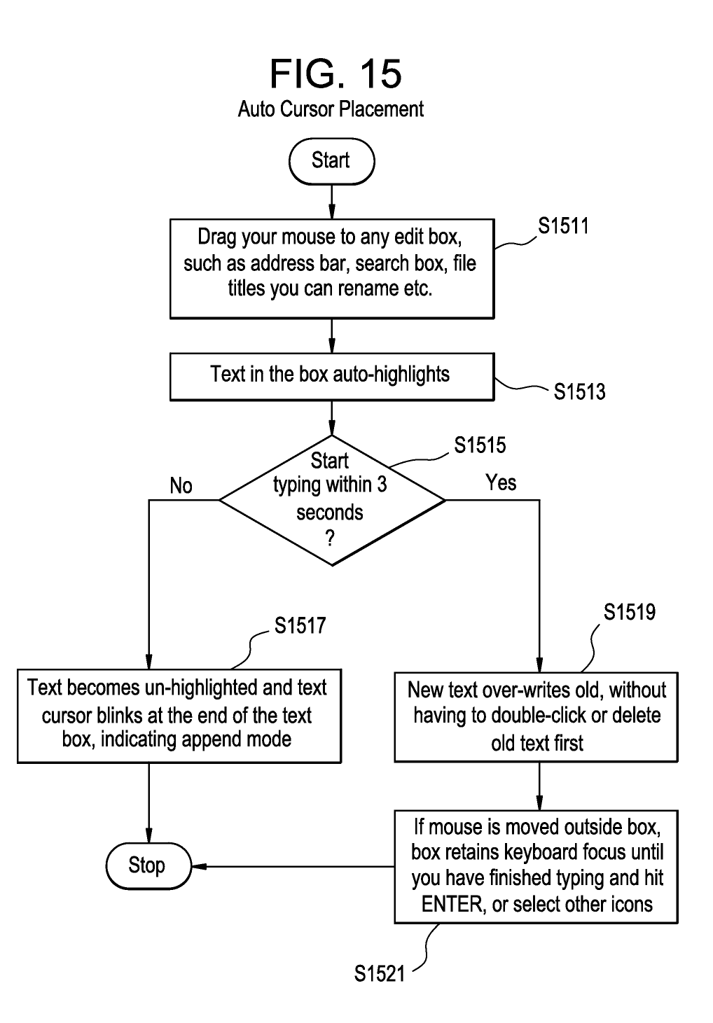

FIG. 15 illustrates an exemplary auto cursor placement process. At S1511, a user may drag a mouse cursor to an object such as an edit box. The edit box may include, but it not limited to, a search box, file titles to be renamed, or the like. At S1513, the text in the box auto-highlights.

At S1515, it is determined whether typing has started within three seconds. If not, then at S1517, the text becomes un-highlighted, and the cursor blinks at the end of the text box, indicating an “append” mode.

If typing has started within three seconds, at S1519, the new text overwrites the old text, without requiring a user to double-click or delete the old text first. At S1521, if the mouse is moved outside of the text box, the text box retains keyboard focus until typing is complete, and the user has so indicated (e.g., by selecting the ENTER key or an icon).

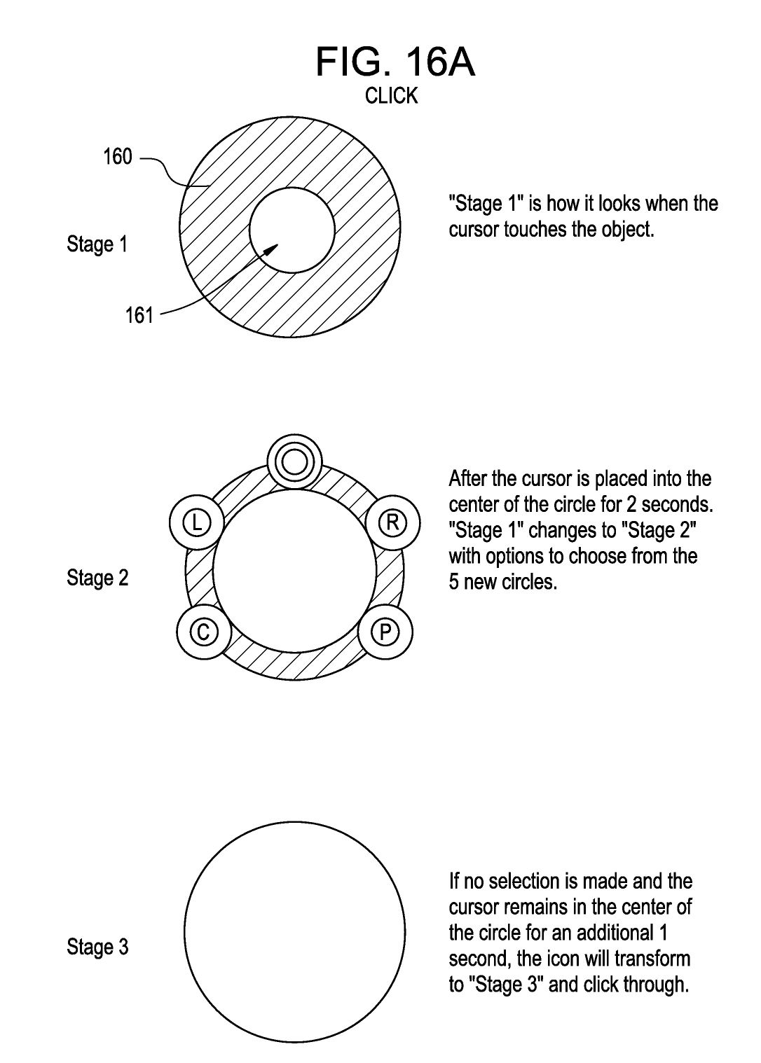

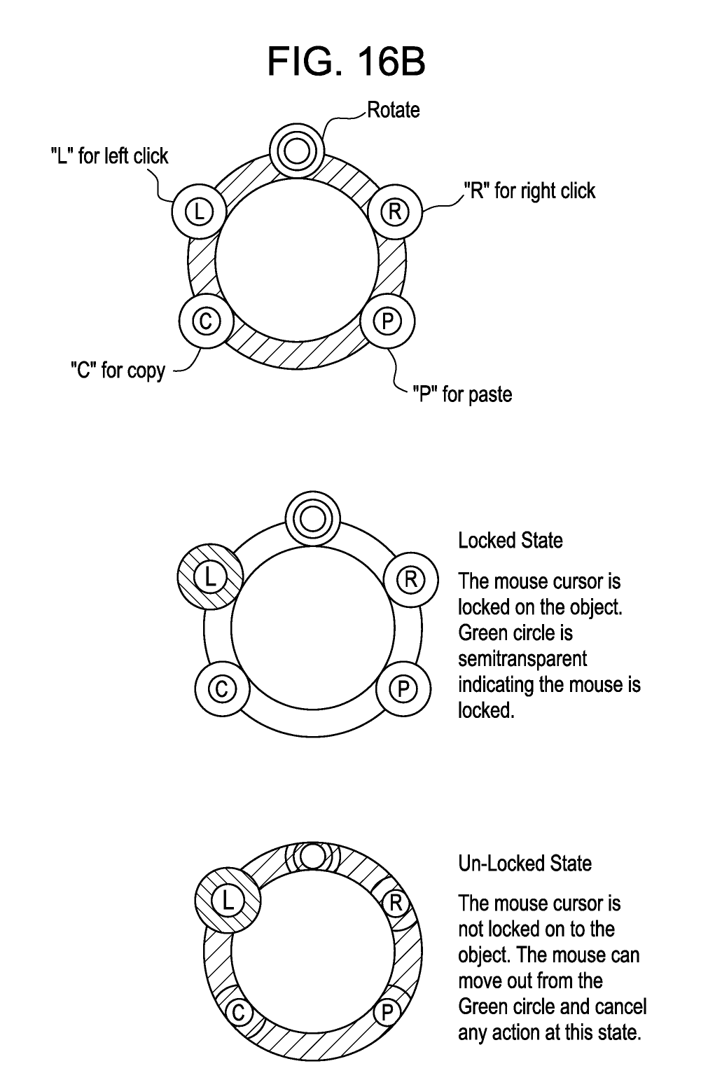

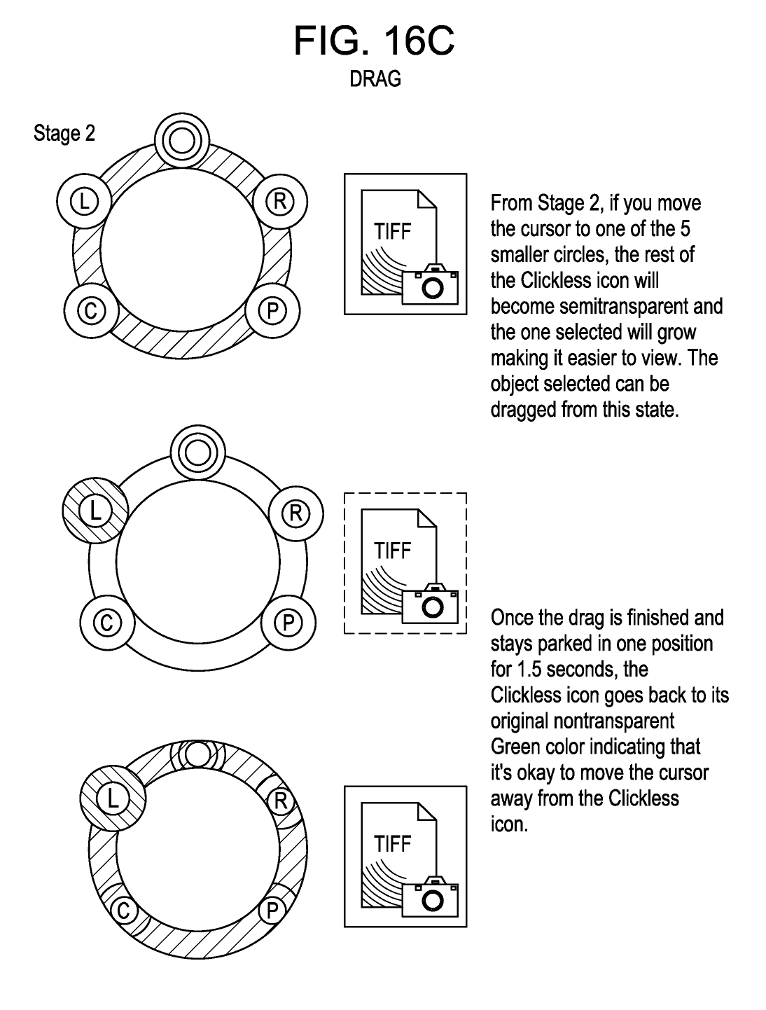

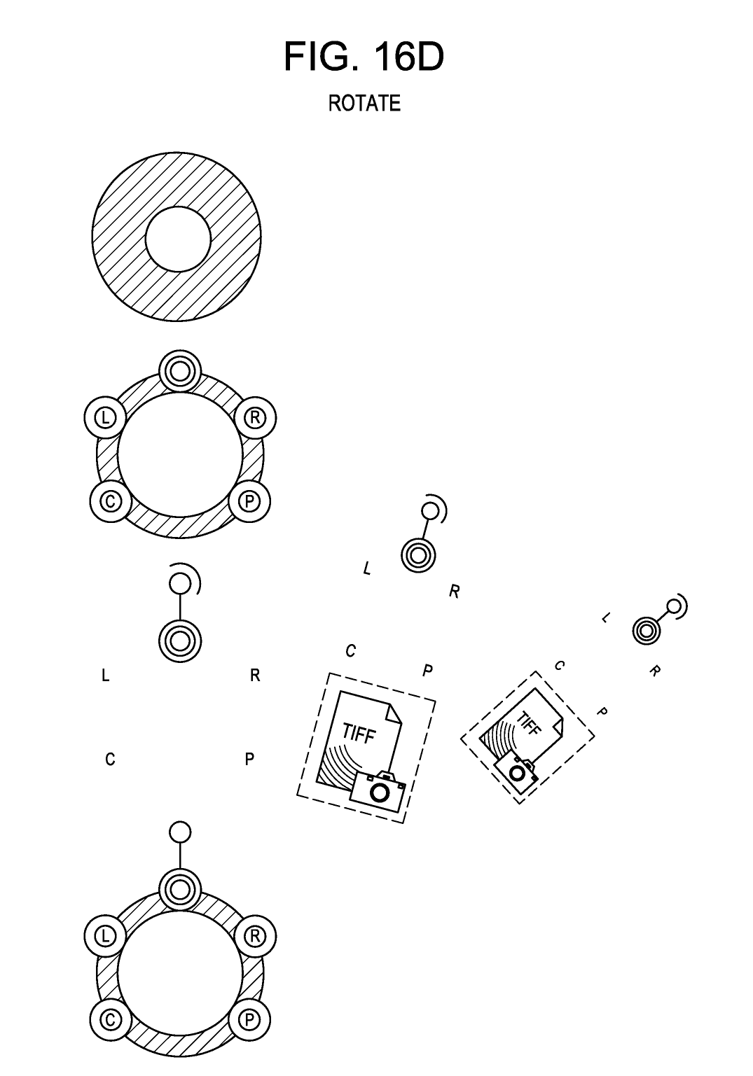

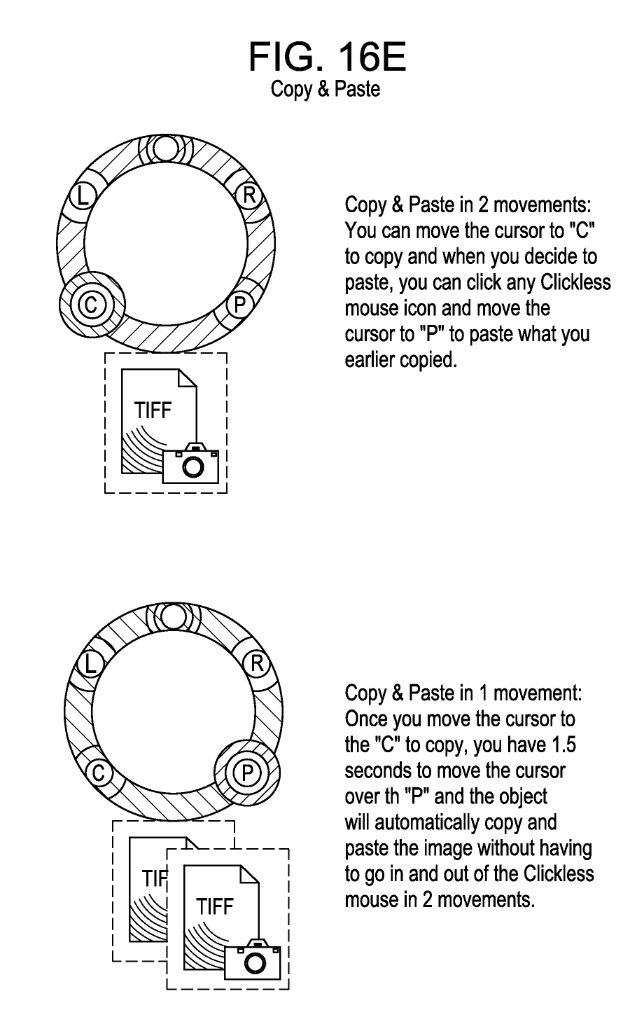

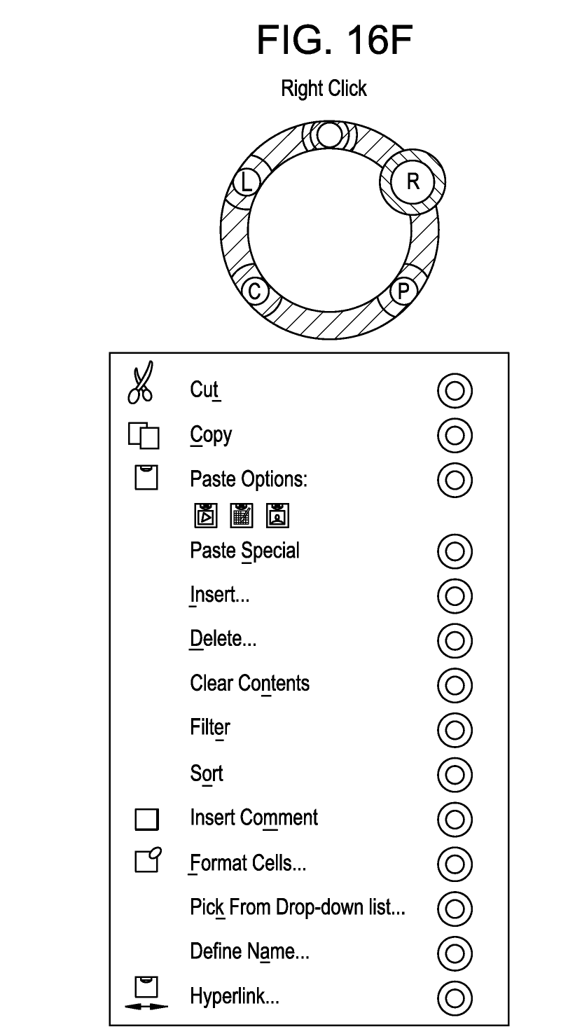

FIGS. 16A-16F illustrate operation of the clickless user interface according to the exemplary embodiment. The indicator is shown as a shaded circle. However, any other indicator having similar functionality, of any shape, texture, color, or other appearance characteristic may be substituted therefor, as would be understood in the art.

FIG. 16A illustrates a user having mouse cursor focus on an object, such that the shaded circle 160 appears having a center 161. For example, the shaded circle 161 may appear when an object is minimally overlapped. This is represented by “Stage 1”.

If a user positions the mouse cursor inside the shaded circle for more than a minimum time, such as, but not limited to, 1.5 seconds, activation of the action for the object is commenced. This activation is indicated to take place by the thinning of the outline of the shaded circle. Once the shaded circle outline has disappeared, the action for the object is invoked. At no point during this process is the user required to click on an input object such as a mouse.

If a user places the mouse cursor on a border of the shaded circle for more than a minimum time such as, but not limited to, two seconds, the appearance of the shaded circle is changed, and a function is activated. In this example, the drag function is activated as the shaded circle becomes semi-transparent. Once dragging has been completed, movement of the object has stopped, and more than two seconds has passed, the shaded circle is transformed in appearance, for example, to its original appearance. So long as the user keeps the mouse cursor on the outline of the object, the object will change appearance when the minimum time has elapsed.

An icon may permit a user to launch the clickless mouse functionality from a desktop. The shaded circle icon may be selected to launch from its minimized state.

As shown in FIG. 16A, if the user places the mouse cursor in the center (e.g., white) area 161 of the shaded circle 160 for a minimum time such as, but not limited to, two seconds, the appearance of the shaded circle is changed and a plurality of buttons are presented for the user to select from a plurality of options. This is shown as “Stage 2” of FIG. 16A.

As shown as “Stage 3” of FIG. 16A, if no selection is made and the cursor remains in the center 161 of the circle 160, the icon transforms to the image shown in “Stage 3”, and clicks through.

As shown in FIG. 16B, for example, but not by way of limitation, in such a state, the circle may have an indication (e.g., semitransparent), indicating that the mouse cursor has locked on the object. On the other hand, when the mouse cursor is not locked on to the object, the mouse can move away from the green circle, thus canceling any action.

In this exemplary embodiment, if the user places the mouse cursor on the “L” button for a minimum time such as, but not limited to, two seconds, the object can be dragged or a “left click” action may be taken. Also in this example, if the user places the mouse cursor on the “center dot” button the object can be rotated. In this example, a “right click” menu can be displayed if the user places the mouse cursor on the “R” button for a minimum time such as, but not limited to, two seconds. Also, in this example, the object can be copied by the user placing the mouse cursor on the “C” button for a minimum time such as, but not limited to, two seconds. Also, in this example, the object can pasted by the user placing the mouse cursor on the “P” button for a minimum time such as, but not limited to, two seconds.

While the foregoing indicators are used, the exemplary embodiments are not limited thereto, and other characters, symbols, colors, patterns, or other distinguishing indications may be provided such that a user can recognize a different between functions at different regions of the indicator.

Further, in this example, the arrangement and positioning of the buttons may be changed by a user through a settings menu. In the settings menu, additional buttons could also be added, or buttons could be deleted by the user. The user can also customize the clickless mouse functionality by adjusting the minimum time necessary to activate the buttons, changing the color of the circle or replace the shaded circle with a custom image through the settings menu.

More specifically, a mouse cursor contacts with an object to generate the image. After the cursor has been placed in the center of the image for a time such as 2 seconds, the image is transformed to the image. If no selection has been made and the cursor remains in the center of the drawing for an additional one second, the icon will be transformed, and the “click through” will be performed.

In an example embodiment of “Stage 2” as shown in FIG. 16A, FIG. 16C illustrates a “drag” function. More specifically, if the mouse cursor is moved to the circle indicated by “L”, the remaining portion of the icon becomes semitransparent. Further, the select choice is distinguished, e.g., enlarged, so that a user can more easily identity the chosen function. Accordingly, the object can be dragged using the mouse in this state. Once the dragging operation has been completed and the object has not been moving for a time period, for example, 1.5 seconds, the icon returns to its nontransparent color, so as to indicate that the mouse cursor may be moved away from the icon without further dragging the object.

Similarly, as shown in FIG. 16D, a rotation operation may be performed. A symbol is provided to indicate that the rotation operation may be performed, and the icon changes to a semitransparent state. After the rotation operation has ceased for a time period, the icon returns to a nontransparent state, indicative that the icon can be moved without causing further rotation.

As shown in FIG. 16E and explained above, a copy and paste function may also be performed in two movements. In a first movement, the cursor is moved to “C”, and the copy function is activated in a manner similar to that as explained above. Accordingly, a copy function may be performed and completed. Then, the cursor is moved to “P” in a separate operation, and the paste function may be performed in a manner similar to that explained above.

As also shown in FIG. 16F and explained above, a right click operation is performed without requiring clicking of the mouse. Upon selection of this feature, a list of options appear, each of which may be activated using the clickless icon function as explained above.

According to another exemplary embodiment, data may be stored in a “cloud server” that is remote from the host PC. With data being securely in “cloud servers”, the OS of the flash memory can generate a user interface that is run directly in a web browser. Alternatively, a flash desktop app version could be downloaded to a desktop or mobile processor, and be set up to run with data residing remotely. When the flash memory device is connected to the host PC, the data is automatically synched and downloaded. Thus, data can be accessed “offline”, e.g., in the absence of an internet connection.

Additionally, the exemplary embodiments provide the ability to customize settings for a hacker alert, such that a notification can be sent, for example, to an email or text to a wireless device.

The OS of the USB flash drive allows for files to be organized based on all the different types of files (music, photo, video, document), into organized menu files. Further, a backup to the USB Flash Drive is created with a single click, without leaving internet or email page information on the host PC. The OS also synchs the USB flash drive with the “cloud” on one or more of the files with a single selection action (e.g., click). Additionally, the OS of the USB flash drive can be accessed automatically from the internet and be synced to the USB flash drive or a specific files from the cloud can be downloaded into the USB Flash drive

The OS of the USB flash drive also provides for functional capability with respect to email, browsing the internet, storing files, and storing passwords. For example, but not by way of limitation, master and slave password and settings account for corporate and parental controlled access are provided.

According to another exemplary embodiment, a “desktop cloud” is provided. A user can register online to set up the USB flash drive. At the user interface, a video loop (e.g., customized) can be displayed, from the host PC or internet. Thus, while the user is using the OS of the USB flash drive via the user interface, a video loops in the background. Additionally, a ticker may be customized to display information (e.g., news, sports, business, weather) on the desktop of the OS. Further, contact information can be customized on the desktop page of the OS.

According to yet another exemplary embodiment, a “cloud browser” is provided. More specifically, the browser comprises a hybrid of USB Flash Drive and an internet browser. A username password protected browser has a built-in USB Flash Drive controller, and the browser that remembers all your passwords but not on the computer. Further, the browser is resident in the OS of the USB flash drive, so that it is portable, and can be operated from any host PC. As explained above, no electronic trail of usage is left at the host PC.

Thus, the exemplary embodiment permits opening of files stored in the USB flash drive without the necessity to close the browser. For example, but not by way of limitation, a user can select music from the USB flash drive while using the browser, and without leaving the page that is being browsed. Optionally, the user may also customize the color of the browser without leaving the browser, with a single selection action (e.g., click).

The browser is available on every page (e.g., Facebook, Twitter, document, photos, website or email page). As user may also push the browser up and out of the way to create space for your document or composing your email on an as-needed basis.

The exemplary embodiment also provides for a tabbing system. Up to 10 rows of tabs, 6 tabs to a row are created. After the 6 tabs, the OS automatically creates the second row of tabs. The colors of the tabs may be customized. The colors may be automatically assigned upon creation of a new tab. The name of the files on the tabs may be changed. Further, the user may permanently affix the tabs on the browser for each logon or delete the tabs upon exit. For example, but not by way of limitation, the tabs may be used as a desktop “rolladex”.

According to yet another exemplary embodiment, an AUTO POPULATING MULTI SEARCH engine is provided that auto populates the search term simultaneously to all the other websites that the user customizes. Such an exemplary embodiment protects any history of search terms typed from the host PC on the USB flash memory, so that such terms could also be typed from a second USB flash memory. Accordingly a user need not retype search terms multiple times, or move page to page, or expend time navigating through additional interfaces (e.g., extra clicks).

The exemplary embodiment also provides for access of multiple emails (e.g., yahoo, google, aol, hotmail, movo email) substantially, simultaneously. In one aspect, movo emails from one user to another movo email user may be deleted with a timer. Further, photos of a contact from Facebook and/or Gmail may be synched to MOVO email according to the OS of the USB flash memory, to access the photos of individuals. Therefore, a user may select an image (e.g., photo) as opposed to typing the email address on the TO, CC or BCC when sending email. Further, the ability to view the images to quickly select an addressee and open up a plurality (e.g., 6) emails of the same company such as gmail, ymail, aol, hotmail or movo mail and compose all the emails substantially simultaneously. As a result, it becomes unnecessary for a user to close, discard, save or exit out of the current draft to compose a different email.

Various advantages and benefits may be provided by the foregoing exemplary embodiments, including, but not limited to:

Software only solution

No proprietary hardware—Ability to download operating system to other USB Flash drives, or other types of removable media

Secure file storage, with ability to lock each file with password protected encryption

Private internet browsing—leaves no footprint on host computer

Central server/web based solution for user registration and remote administration

Secure Email includes password protected privacy, encrypted storage, timed delete of messages, and no footprint on host computer

Proprietary opt-in peer to peer messaging provides guaranteed Spam—free and virus free delivery of critical Emails/Data between users

Secure storage of account numbers, PINs and passwords

Multimedia storage and management

Customizable flash and video based user interface

Seamless inter-operation on multiple host operating systems, including at the minimum, Windows and Macintosh environments

Registered user access, ability to block remotely if device is lost, and remote locate proximity by IP address for unauthorized access (which can notify cell phone & Email)

“Lost and Found” feature

User interface included “self destruct” button for quick erasure of all sensitive data

Remote storage and synchronization of data with “the cloud”, and ability to run the secure desktop off the cloud

The foregoing exemplary embodiments refer to an OS in the flash memory device. However, any computer-readable medium that may be connected to a host PC may be substituted therefore without departing from the scope of the inventive concept.

Alternatively, the foregoing browser and email interface can be downloaded to the host PC in addition to, and independent of, the USB flash memory device. Thus, a user can have a substantially common experience between using the browser on the host PC and using the browser with the OS of the USB flash memory.

The present application provides further features in comparison with existing art, as explained below.

U.S. Pat. No. 7,735,145 B2, Entitled “Portable Secure Media with Timed Erasure”, discloses a USB storage device with specialized hardware to perform a timed erasure of the data on the thumb drive. In contrast, this exemplary embodiment is a software only solution for timed erasing of files. Accordingly, existing related art hardware can be used to implement the inventive concept of the exemplary embodiments.

US Patent Application 2008/0066174 A1 Entitled “Secure Memory Storage Device”, presents a manner of secure storage that requires proprietary hardware; the USB storage device itself has buttons and a display to create the password protection environment. However, this is an expensive and hard to access solution for the average consumer. In contrast, the exemplary embodiments provide a software encryption/access solution, that allows the storage to be had on a related art USB storage device, for example, for which the OS has been installed by download.

US Patent Application 2010/0293374 A1, Entitled “Secure Portable Memory Storage Device” depicts a wireless secure authentication system to control transfer of data over USB. In contrast, this exemplary embodiment does not require proprietary hardware, as the authentication is done through a combination of the software on the flash memory device, the host computer's internet connection, and the cloud-based authentication server.

US Patent Application 2007/0112981 A1 Entitled “Secure USB Storage Device” depicts a USB storage device with an integrated display and buttons to allow entry of a PIN to protect/access data. In contrast, this exemplary embodiment is directed to a software solution loaded on a related art USB thumb drive. An example computing environment is also provided with an example computing device suitable for implementing at least one example embodiment. The computing device in the computing environment can include one or more processing units, cores, or processors, memory, internal storage, and I/O interface, all of which can be coupled on a communication mechanism or bus for communicating information.

The computing device can be communicatively coupled to input/user interface and output device/interface. Either one or both of input/user interface and output device/interface can be wired or wireless interface and can be detachable. Input/user interface may include any device, component, sensor, or interface, physical or virtual, that can be used to provide input. In some example embodiments, input/user interface and output device/interface can be embedded with or physically coupled to computing device.

The computing device can be communicatively coupled to external storage and network for communicating with any number of networked components, devices, and systems, including one or more computing devices of same or different configuration.

I/O interface can include, but is not limited to, wired and/or wireless interfaces using any communication or I/O protocols or standards for communicating information to and/or from at least all the connected components, devices, and network in computing environment. Network can be any network or combination of networks.

The computing device can use and/or communicate using computer-usable or computer-readable media, including transitory media and non-transitory media.

The computing device can be used to implement techniques, methods, applications, processes, or computer-executable instructions to implement at least one embodiment. Computer-executable instructions can be retrieved from transitory media, and stored on and retrieved from non-transitory media. The executable instructions can be originated from one or more of any programming, scripting, and machine languages.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A flash memory device having an operating system, the flash memory device comprising:
means for restricting user access by providing at least one of password protection and encryption, wherein the flash memory device may be registered to an owner;
means for detachably attaching the flash memory device to a host computer so as to permit the operating system of the flash memory to control operation thereof, wherein no electronic data indicative of attachment of the flash memory device remains; and
means for providing a user interface having at least one of email communication capabilities, auto-populating multi-search, and tabbing, wherein the user interface may be run from at least one of the host computer and a remote processor, and
wherein the user interface does not require a click event to activate an object.

2. A method of providing an interface, comprising:
restricting user access by providing at least one of password protection and encryption, based on registration to an owner;
detachably attaching a flash memory device to a host computer so as to permit an operating system of the flash memory to control operation of the host computer, wherein no electronic data indicative of attachment of the flash memory device remains; and
providing a user interface having at least one of email communication capabilities, auto-populating multi-search, and tabbing, wherein the user interface may be run from at least one of the host computer and a remote processor, and wherein the user interface does not require a click event to activate an object.

3. A user interface configured to be operated and controlled by a computer readable medium containing instructions for a flash memory device having an operating system, the user interface comprising:
an input for restricting user access by providing at least one of password protection and encryption, based registration of the flash memory device to an owner, wherein the flash memory device can be detachably attached to a host computer so as to permit the operating system of the flash memory to control operation thereof, wherein no electronic data indicative of attachment of the flash memory device remains; and
means for providing at least one of email communication capabilities, auto-populating multi-search, and tabbing,
wherein the user interface may be run from at least one of the host computer and a remote processor, and
wherein the user interface does not require a click event to activate an object.
